(19) United States
(12) Patent Application Publication
(10) Pub. No.: US 2007/0292594 A1
(43) Pub. Date: Dec. 20, 2007

(54) PLANT MATERIAL PET TREAT

(75) Inventor: Mark Levin, Papillion, NE (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: SERGEANT'S PET CARE PRODUCTS INC., Omaha, NE (US)

(21) Appl. No.: 11/425,060

(22) Filed: Jun. 19, 2006

(51) Int. Cl. A23J 1/00

(52) U.S. Cl. 426/656

(57) ABSTRACT

The present invention relates to a moist pet treat and a method for making the pet treat. In particular, the pet treat is formed from a textured plant based protein material and a humectant.

### FIELD OF THE INVENTION

The present invention relates to a moist pet treat and a method for making the pet treat. In particular, the pet treat is formed from a plant material and a humectant.

### BACKGROUND OF THE INVENTION

Pet owners have a variety of commercially available pet treats to choose from, including rawhide, jerky treats, and biscuits. The treats can be divided into two areas 1) treats made from animal parts and 2) treats that include grain flour, starch, and palatability enhancers. Regardless of whether the treat is primarily animal based or starch based, cats and dogs are attracted to pet treats having a meat taste.

Animal based products are usually by-products including ears, snouts, hooves, and other animal parts. By-products have a couple of problems; first bacteria, mold, and yeast will grow on these products if the moisture content is higher than 14%. If the moisture content is less than 14% it is likely that the treats are hard and in some cases brittle. Most of the by-products are cooked in an oven-like process and dried to a moisture content of less than 15%, whereby most of the free water has been removed. This moisture content is critical to make the product shelf stable. The resultant low moisture content yields a hard treat, such as a cooked and dried pig ear. Currently, available animal pet treats made with bones, rawhide, cow tails, pig ears and cow snouts, are generally very hard and not very easy for a pet to chew. Generally, younger pets with undeveloped teeth or older pets having fewer teeth also have a hard time with these types of treats. Thus, animal by-products suffer from either too much moisture or being hard and sometimes brittle.

Currently, there are pet foods and pet treats that include vegetable proteins, carbohydrates, and humectants. The carbohydrate adds to the structure and texture of the pet food to create a product that is stable and easy to feed to pets. Treats or feeds that include carbohydrates have a number of problems. When excessive carbohydrates are included in a pet's diet the carbohydrates have been known to cause medical problems in pets, including obesity, diabetes, and maldigestion. Obesity occurs when an animal's energy needs are exceeded and the extra glucose created by the digestion of the carbohydrates is stored as fat. In addition, as carbohydrates pass through the digestive tract, enzymes such as amylase, lactase, maltase, sucrase, and disaccharidase break down carbohydrates into usable forms, but some animals have deficiencies in these enzymes resulting in inadequate digestion of the carbohydrates. The undigested carbohydrates ferment and create bacterial overgrowth resulting in the production of gas and excess water, which causes maldigestion. Pet treats that include carbohydrates may also leave a paste residue on a pet's tooth. This residue may over time cause microbial growth, plaque build-up, cavities, and/or other dental problems. As such, pet treats that are similar to a carbohydrate enriched treat, but which contain significantly reduced carbohydrates and are less likely to result in obesity, diabetes, mild digestive problems, and dental problems are preferred. Therefore a need exists for pet foods and pet treats that are soft, palatable, and healthy for the pet without the addition of a carbohydrate or animal based product.

### SUMMARY OF THE INVENTION

The present invention is directed to a pet treat formed from a textured plant based protein material and an amount of a humectant. The present invention also includes methods for producing the product. Further the pet treat may also include other components to enhance flavor or add benefits to the treat nutritionally or functionally. Resultant treats include humectant infused textured soy and wheat proteins that are moist.

The process includes contacting the textured plant based protein material with a humectant to form the moist pet treat. The humectant infuses into the pet treat. The resultant treat will have an interactivity such that growth of bacteria and fungus will be inhibited. Even though the water activity is comparatively low, the amount of water present will be sufficient to prevent the treat from being brittle and hard. As such, the water will cause the treat to be soft and pliable.

Ultimately, for example, a textured wheat protein or textured soy protein treat can be produced that has a soft pliable texture, is shelf-stable, and has reduced water activity.

### DESCRIPTION OF THE PREFERRED EMBODIMENTS

In accordance with the present invention, a process for making a moist pet treat derived from plant based protein materials has been developed. Related to the process, the resultant pet treats derived from the plant based protein material have also been discovered. In particular, the invention allows for the use of textured plant based proteins, such as textured soy and textured wheat proteins, without the inclusion of carbohydrates. The resultant treat is shelf stable and of a soft and pliable nature. Thus, a product can be produced that is derived from plant based protein materials, but has a reduced water activity. The product will also contain a sufficient amount of water and other constituents, while maintaining stability at ambient conditions. The moist pet treat of the present invention is generally made by a process that includes contacting a dry textured plant based protein material with a humectant.

A textured plant based protein material, as used herein, means a vegetable protein that has been concentrated or isolated from a plant, is hydrated and processed in a way to set the protein into a non-reversible texture and sometimes into a linear fibrous texture. Suitable textured plant based protein materials include any textured plant protein, such as a textured vegetable protein, a textured soy protein, a textured wheat protein, a textured pea protein, a textured corn protein, textured peanut protein, and mixtures thereof. Textured wheat proteins may be purchased commercially from, for example, Midwest Grain Products under the trademark Wheatex®. Textured soy proteins may be purchased commercially from, for example, Archer Daniels Midland (ADM) under the trademark Arcon®. Textured plant based protein materials may also be made in accordance with methods generally known in the art, for example, as detailed in U.S. Pat. Nos. 3,940,495, 3,496,858, 3,962,335, which are hereby incorporated by reference in its entirety. For example, a method of making a textured soy protein includes extruding a mixture of soybean meal and water, by any method generally known in the art, and cutting or forming it to its desired shape following extrusion. Generally, the extruded textured protein is very porous and has a fibrous network which somewhat resembles the appearance of various beef, poultry, pork, fish, or seafood products. Alternatively, the textured protein may be dried, merely by passing it through a conventional drying chamber. In such a form, the dried textured protein resembles cereal products. Typically, a dried textured protein may be hydrated to resemble the appearance of a meat product.

The textured plant based protein material of the present invention may be produced in various sizes or shapes. In particular, following extrusion, the textured vegetable protein may be cut or shaped to look like shredded meat, meat chunks, meat flakes, meat cuts, or typical pet treat shapes such as sticks, strips, cookie-type shapes, and bar-type shapes. The pet treat may also be multi-textured, colored, or multi-flavored.

A humectant is then added to the textured plant based protein material to soften the textured plant based protein material and form a shelf stable product that is soft and easy to chew. A humectant is a hygroscopic substance that is generally used as a food additive. The hygroscopic substance binds water, meaning the water is not available to microorganisms. In addition, because a humectant binds water, bacterial or mold growth that could potentially occur when moistened food products are left at ambient conditions, is prevented. Water, however, is important to maintain the pliable nature of the product.

As such, the plant based protein material is subjected to an infusion operation where the humectant solution is contacted with the textured plant based protein material to form an infused plant based protein product. Essentially, the humectant or humectant solution will infuse into the textured protein. Preferably, the plant based protein material is contacted with a humectant or humectant solution at a temperature and for a time sufficient to bind any excess water with the humectant and to soften the textured plant based protein product.

The infusion operation comprises contacting the textured plant based protein product with a humectant or humectant solution in a suitable vessel to soften the plant based protein product. Typically, the temperature of the humectant during the infusion operation is from about 15° C. to about 50° C., more preferably from about 20° C. to about 35° C. The infusion operation typically lasts for between 10 min to about 14 days, preferably from about 20 min to about 7 days. Alternatively, the humectant may be vacuum infused into the textured plant based product.

The suitable humectants include propylene glycol, glycerin, sorbitol, mannitol, xylitol, maltitol, corn syrup, sugars, alcohol sugars, mineral salts, metal salts, and mixtures thereof. Available metal and mineral salts include sodium chloride, calcium chloride, and potassium chloride. The preferred humectant used in the infusion operation is propylene glycol, glycerin, hydrogenated starch hydrolyzates, or mixtures thereof. Of course those skilled in the art will appreciate that any other humectant suitable for consumption may be used in accordance with the present invention.

The concentration of the humectant and water mixture may vary depending on the initial moisture content present in the plant based protein material being infused. The humectant and water mixture may include from about 30% to about 99% by weight humectant and from about 1% to about 70% by weight water. Preferably, the infusion operation comprises contacting the plant based protein material with a mixture of from about 50% to about 90% by weight humectant and from about 10% to about 50% by weight water.

Generally, a moist pet treat is a pet treat having soft and pliable characteristics reminiscent of a higher moisture-containing product. Those skilled in the art will appreciate that the moisture content will vary depending on the desired texture of the pet treat and the humectant type. An acceptably low moisture content can lead to a safe and shelf stable product that exhibits a water activity of from about 0.4 to about 0.85.

The process of making a moist pet treat may be conducted in a batch, semi-continuous, or continuous mode and it may be carried out using a variety of apparatus and process techniques. In some instances, some process steps may be omitted or combined with other process steps without departing from the scope of the present invention.

After the infusion operation, the textured plant based protein product may be subjected to a removal operation, whereby excess humectant solution is removed from the pet treat. Preferably, after the plant based protein product is removed from the mixture of humectant and water it is placed on a drying rack at ambient conditions so that any excess humectant solution is either absorbed by the plant based protein product or allowed to air dry. An alternate method for removing excess solution is by physically expelling it by compression.

The resultant moist pet treat has at least about 50% by weight textured plant based protein material. Preferably, the moist pet treat comprises from about 45% to about 80% by weight textured plant based protein material, from about 3% to about 30% by weight humectant, and from about 3% to about 25% by weight water. In addition, the pet treat of the present invention will have a water activity of less than about 0.85, more preferably less than about 0.75, even more preferably less than about 0.65, and yet more preferably less than about 0.6. To maintain a water activity of from about 0.65 to about 0.85 in the pet treat, it may also be necessary to add mold inhibitors and acids to adjust the pH of the humectant solution.

In addition to a textured plant based protein material and humectant, the moist pet treat may comprise other additives such as palatability enhancers, seasonings or coloring agents to improve the taste and or appearance of the pet treat. The palatability enhancer may be selected from the group consisting of natural flavors, artificial flavors, meat concentrates, dairy powders, dairy concentrates, fruit concentrates, vegetable powder, and mixtures thereof. [When added] In addition, the present invention may also include herbal extracts for health benefits, enzymes for digestive disorders, vitamins for nutritional benefits, among others.

The pet treat of the present invention may also include additives to improve the shelf-stability of the pet treat. Suitable additives include sodium benzoate, calcium propionate, and phosphoric acid.

The moist pet treat of the present invention retains its moisture even after exposed to atmospheric conditions for an extended period of time.

The following examples are simply intended to further illustrate and explain the present invention. The invention, therefore, should not be limited to any of the details in these examples.

### DEFINITIONS

Water activity, or a_{w}, is the relative availability of water in a substance. It is defined as the vapor pressure of water in a product divided by that of pure water at the same temperature. Higher a_{w} substances tend to support more microorganism. Bacteria usually require at least 0.91, fungi at least 0.7, and mold as low as 0.62.

### EXAMPLES

### Example 1

50 grams of chunk Wheatex®, Textured Wheat Protein manufactured by Midwest Grain Products, was placed in a plastic zip lock bag along with 50 grams of humectant solution and allowed to absorb the humectant solution. The humectant solution infused into the textured protein to soften and hydrate the protein. The humectant solution included 25 grams of water and 25 grams of glycerin. The plastic bag was sealed and monitored daily for seven days at ambient conditions.

The water activity of the humectant solution was 0.79, prior to its addition to the textured wheat protein. The water activity of the textured wheat protein was 0.45, prior to contacting it with the humectant. After contacting the humectant solution with the textured wheat protein and allowing the humectant to infuse and hydrate the protein for seven days, the water activity of the humectant solution infused textured wheat protein was 0.6.

The humectant solution infused textured wheat protein was a suitable, shelf stable product exhibiting a soft and chewy texture.

### Example 2

Six different humectant solutions that include fruit or meat flavored palatability enhancers were prepared as illustrated in Table 1. Each humectant solution was placed in a separate plastic zip lock bag along with 50 grams of shredded Wheatex®, Textured Wheat Protein manufactured by Midwest Grain Products.

TABLE 1

| | | | |
|---|---|---|---|
| Humectant Solution 1 | 25 g of Glycerin | 24.75 g of Water | 0.25 g of Strawberry Flavor |
| Humectant Solution 2 | 25 g of Glycerin | 24.75 g of Water | 0.25 g of Apple Flavor |
| Humectant Solution 3 | 25 g of Glycerin | 24.5 g of Water | 0.5 g of Banana Flavor |
| Humectant Solution 4 | 25 g of Glycerin | 24.5 g of Water | 0.5 g of Beef Flavor |
| Humectant Solution 5 | 25 g of Glycerin | 24 g of Water | 1.0 g of Pork Flavor |
| Humectant Solution 6 | 25 g of Glycerin | 24 g of Water | 1.0 g of Chicken Flavor |

Each plastic bag was sealed allowing the humectant solution to infuse and hydrate the textured protein for seven days.

Each humectant solution infused textured wheat protein was a suitable, nutritious, shelf stable product exhibiting a soft and chewy texture and having improved palatability.

### Example 3

50 grams of flake textured soy protein manufactured by Archer Daniels Midland Company (ADM), was placed in a plastic zip lock bag along with 50 grams of humectant solution. The solution included 17 grams of water and 33 grams of glycerin. The plastic bag was sealed and monitored daily for fourteen days.

The water activity of the humectant solution was 0.69, prior to its addition to the textured soy protein. The water activity of the textured soy protein was 0.45, prior to contacting it with the humectant. After contacting the humectant solution with the textured soy protein and allowing the humectant to infuse and hydrate the protein for fourteen days, the water activity of the humectant solution infused textured soy protein was 0.55.

The humectant solution infused textured soy protein was a suitable, shelf stable product exhibiting a soft and chewy texture.

### Example 4

A 50 gram bar of shaped textured wheat protein was placed in a container with 45 grams of humectant solution. The solution included 15.3 grams of water and 29.7 grams of glycerin. The container was sealed and monitored for 60 days.

The water activity of the humectant solution was 0.69, prior to its addition to the bar. The water activity of the bar was 0.45, prior to contacting it with the humectant. After contacting the humectant solution with the bar and allowing the humectant to infuse and hydrate the bar for 7 days, the water activity of the humectant solution infused bar was 0.55.

The humectant solution infused textured soy protein was a suitable, shelf stable product exhibiting a soft and chewy texture.

The above description of the preferred embodiments is intended only to acquaint others skilled in the art with the invention, its principles, and its practical application, so that others skilled in the art may adapt and apply the invention in its numerous forms, as may be best suited to the requirements of a particular use. The present invention, therefore, is not limited to the above embodiments, and may be variously modified.

With reference to the use of the word(s) “comprise” or “comprises” or “comprising” in this specification (including the claims), Applicants note that unless the context requires otherwise, those words are used on the basis and clear understanding that they are to be interpreted inclusively, rather than exclusively, and that Applicants intend each of those words to be so interpreted in construing this specification (including the claims).

What is claimed is:

1. A process of making a moist pet treat, the process consisting of contacting a textured plant based protein material selected from the group consisting of a textured vegetable protein, a textured soy protein, a textured wheat protein, a textured pea protein, a textured corn protein, a textured peanut protein, and mixtures thereof with a humectant to cause formation of a moist humectant infused pet treat having a water activity of less than 0.85.

2. The process of claim 1, wherein the humectant is selected from the group consisting of propylene glycol, glycerin, sorbitol, mannitol, xylitol, maltitol, corn syrup, sugars, alcohol sugars, mineral salts, metal salts, and mixtures thereof.

3. The process of claim 1, further comprising adding a palatability enhancer to the textured plant based protein material.

4. The process of claim 3, wherein the palatability enhancer is selected from the group consisting of natural flavors, artificial flavors, meat concentrates, dairy powders, dairy concentrates, fruit concentrates, vegetable powder, and mixtures thereof.

5. The process of claim 1, wherein the textured plant based protein material is contacted with the humectant for from about 20 minutes to about 7 days.

6. The process of claim 1, further comprising contacting the textured protein with water; wherein the humectant and water mixture comprise from about 30% to about 99% by weight humectant and from about 1% to about 70% by weight water.

7. A process of making a moist pet treat, the process comprising:
a. contacting a textured plant based protein material with a mixture of humectant and water, the mixture comprising from about 30% to about 99% by weight humectant and from about 1% to about 70% by weight water; and,
b. removing any excess mixture from the textured plant based protein material to produce a moist pet treat having a water activity of less than 0.85.

8. The process of claim 7, wherein the textured plant based protein material is selected from the group consisting of a textured vegetable protein, a textured soy protein, a textured wheat protein, a textured pea protein, a textured corn protein, a textured peanut protein, and mixtures thereof.

9. The process of claim 7, wherein the humectant is selected from the group consisting of propylene glycol, glycerin, sorbitol, mannitol, xylitol, maltitol, corn syrup, sugars, alcohol sugars, mineral salts, metal salts, and mixtures thereof.

10. The process of claim 7, wherein the textured plant based protein material is contacted with the humectant for from about 20 minutes to about 7 days.

11. A moist pet treat consisting of:
a. a textured plant based protein material selected from the group consisting of a textured vegetable protein, a textured soy protein, a textured wheat protein, a textured pea protein, a textured corn protein, a textured peanut protein, and mixtures thereof; and,
b. a humectant, whereby the pet treat has a water activity of less than 0.85.

12. The pet treat of claim 11, wherein the humectant is selected from the group consisting of propylene glycol, glycerin, sorbitol, mannitol, xylitol, maltitol, corn syrup, sugars, alcohol sugars, mineral salts, metal salts, and mixtures thereof.

13. The pet treat of claim 11, further comprising a palatability enhancer.

14. The pet treat of claim 13, wherein the palatability enhancer is selected from the group consisting of natural flavors, artificial flavors, meat concentrates, dairy powders, dairy concentrates, fruit concentrates, vegetable powder, and mixtures thereof.

15. The pet treat of claim 11, wherein the pet treat comprises from about 45% to about 80% by weight textured plant based protein material, from about 3% to about 30% by weight humectant, and from about 3% to about 25% by weight water.

16. A textured soy protein treat consisting of a humectant and a textured soy protein, whereby the pet treat has a water activity of less than 0.85.

17. A textured wheat protein treat consisting of a humectant and a textured wheat protein, whereby the pet treat has a water activity of less than 0.85.

18. The treat of claim 16, wherein the treat comprises from about 45% to about 80% by weight textured soy protein, from about 3% to about 30% by weight humectant, and from about 3% to about 25% by weight water.

19. The treat of claim 17, wherein the treat comprises from about 45% to about 80% by weight textured wheat protein, from about 3% to about 30% by weight humectant, and from about 3% to about 25% by weight water.
